(19) United States
(12) Patent Application Publication
(10) Pub. No.: US 2012/0007807 A1
(43) Pub. Date: Jan. 12, 2012

(54) Full keyboard remote control

(76) Inventor: Edward Zheng, Wanchai (HK)

(21) Appl. No.: 12/932,723

(22) Filed: Mar. 4, 2011

Related U.S. Application Data
(60) Provisional application No. 61/399,181, filed on Jul. 7, 2010.

(51) Int. Cl. G06F 3/033; G06F 3/02

(52) U.S. Cl. 345/167; 345/169; 345/157

(57) ABSTRACT

A remote controller includes a housing, a CPU, an input module, and an output module. The input module is electrically connected to the CPU for selectively inputting signals into the remote controller to controllably communicate with the home entertaining appliance. It includes a plurality of control keys provided on the housing for allowing a user to input at least one command to the CPU for interactively communicating with the home entertaining appliance, and a full keyboard arrangement provided on the housing and has a full keyboard set comprising a plurality of information keys for being selectively pressed to input at least one command to the corresponding the CPU. The output module is wirelessly linked with the home entertaining appliance for wirelessly transmitting the inputted commands of the input module to the home entertaining appliance.

### CROSS REFERENCE OF RELATED APPLICATION

This is a non-provisional application that claims the benefit of priority under 35U.S.C. §119 to a non-provisional application, application No. 61/399,181, filed Jul. 7, 2010.

### BACKGROUND OF THE PRESENT INVENTION

1. Field of Invention

The present invention relates to a remote controller, and more particularly to a remote controller with full keyboard arrangement for remotely controlling the home entertainment appliances, such as television (TV), or television box.

2. Description of Related Arts

Traditionally, full keyboards have been commonly incorporated with computer system, mobile phones, or even GPS devices for entering the addresses of destinations or inputting information to communicate with the devices. Those keyboards generally have a universal arrangement with predetermined locations of each of the letters or the likes, so that a user of the keyboard is able to memorize the locations of the letters for quickly and conveniently entering the words or sentences as the user desired. The keyboards have become one of the most powerful input methods for searching and communicating with the PC, cell phone, or the likes.

Furthermore, the keyboard permits the users for entering the data to communicate with the portable devices as mentioned above, so that the devices with the keyboard are able to optimize the function thereof, such as searching the contact information stored in the hard drive of the devices. Therefore, a user has no need to browse the entire catalogue in order to search and select the desired directory for reaching the predetermined information in the device, which may be time consuming.

On the other hand, the conventional remote controllers, such as the television remote controller, are widely used for remotely controlling devices, especially for home entertaining devices, such as for controlling television for switching channels and turning power on and off. However, the data base of the home entertaining device normally has a bundle of selections or information, so that it is time consuming that the user has to browse the enter data base in order to search and find out one of the desired selections thereof. Therefore, the present invention efficiently incorporated the full keyboard arrangement with the remote controller for providing another input method for remotely and efficiently controlling the respective home appliances.

### SUMMARY OF THE PRESENT INVENTION

The invention is advantageous in that it provides a remote controller with full keyboard arrangement, so that a user is able to remotely control one or more home entertaining appliances for searching and finding contents information of the appliances quickly through the full keyboard arrangement.

Another advantage of the invention is to a remote controller with full keyboard arrangement, wherein full keyboard arrangement incorporated with the compact sized remote controller without substantially alternating the configuration thereof allows the user inputting information in conventional inputting manner to provide a user friendly remote controller.

Another advantage of the present invention is to provide a remote controller with full keyboard arrangement, wherein the full keyboard arrangement is provided for the user inputting information via the keyboard arrangement by either one hand or two hands.

Another advantage of the present invention is to provide a remote controller with full keyboard arrangement, wherein the remote controller is able to apply on television and its related devices, so that the user is able to quickly and conveniently input the desired directory or information, such as name of channel, through the full keyboard arrangement.

Another advantage of the present invention is to provide a remote controller with full keyboard arrangement, wherein the display screen is able to show the related information of the home entertaining appliances.

Additional advantages and features of the invention will become apparent from the description which follows, and may be realized by means of the instrumentalities and combinations particular point out in the appended claims.

According to the present invention, the foregoing and other objects and advantages are attained by providing a remote controller for at least one home entertaining appliance, comprising:

a housing;

a CPU received in the housing;

an input module electrically connected to the CPU for selectively inputting signals into the remote controller to controllably communicate with the home entertaining appliance, wherein the input module comprises:

a plurality of control keys provided on the housing for allowing a user to input at least one command to the CPU for interactively communicating with the home entertaining appliance; and

a full keyboard arrangement provided on the housing and has a full keyboard set comprising a plurality of information keys for being selectively pressed to input at least one command to the corresponding the CPU; and

an output module electrically connected to the CPU and wirelessly linking with the home entertaining appliance for wirelessly transmitting the inputted commands of the input module to the home entertaining appliance, such that the user is able to remotely control the appliances via the input module of the remote controller.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a remote controller according to a preferred embodiment of the present invention.

FIG. 2 is a perspective view of the remote controller according to the preferred embodiment of the present invention.

FIG. 3 is a schematic view of an alternative remote controller according to the preferred embodiment of the present invention.

FIG. 4 is a perspective view of a first alternative mode of the remote controller according to the above preferred embodiment of the present invention.

FIG. 5 is a perspective view of a second alternative mode of the remote controller according to the above preferred embodiment of the present invention.

FIG. 6 is a block diagram of the multimedia controller illustrated in the second alternative mode of the remote controller according to the above preferred embodiment of the present invention.

FIG. 7A and FIG. 7B are perspective views of a multimedia controller according to a second alternative mode of remote controller according to the above preferred embodiment of the present invention.

### DETAILED DESCRIPTION OF THE PREFERRED EMBODIMENT

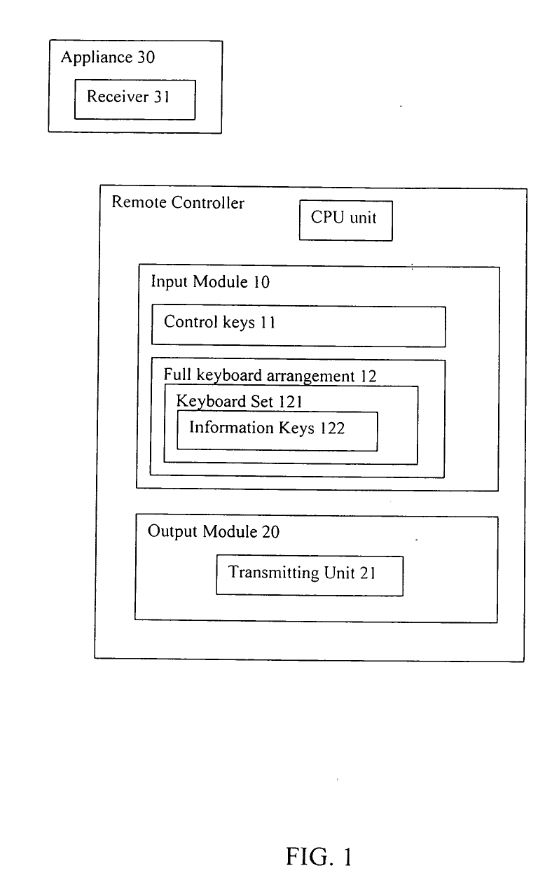

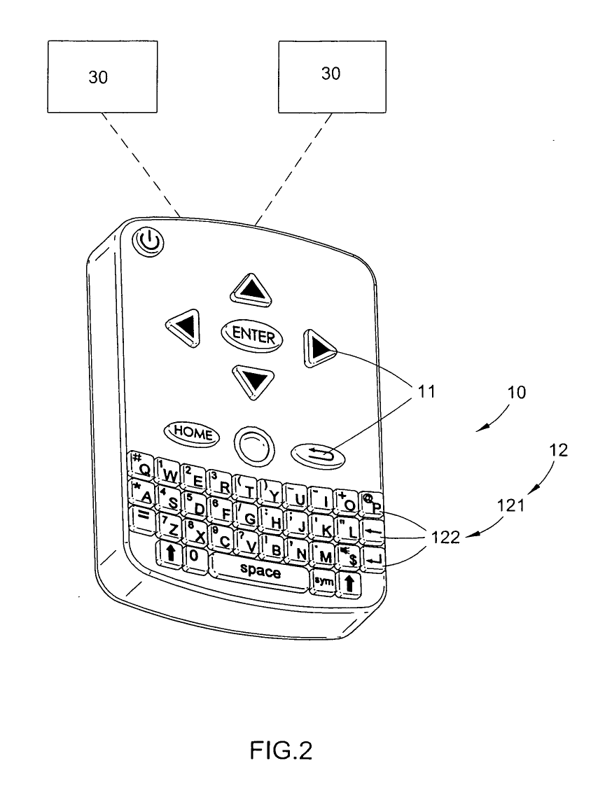

Referring to FIG. 1 to FIG. 3 of the drawings, a remote controller for at least one home entertaining appliance 30 such as a television, DVD player, or speakers according to a preferred embodiment of the present invention is illustrated, in which the remote controller comprises a housing 50, a central processing unit (CPU) 40 received in the housing 50, an input module 10, and an output module for remotely controlling the home entertaining appliance 30 through the remote controller.

The input module 10 is electrically connected to the CPU 40 for selectively inputting signals into the remote controller to controllably communicate with the home entertaining appliance 30, wherein the input module 10 comprises a plurality of control keys 11 and a full keyboard arrangement 12. The control keys 11 are provided on an upper portion of the housing 50 for allowing a user to input at least one command to the CPU 40 for interactively communicating with the home entertaining appliance 30. The control keys 11 are for browsingly searching and selecting the selections of the appliance 30, so that the user is able to input the commands via the control keys 11. For example, the control keys 11 may have an UP key and a DOWN key, so that the user is able to switch and browse the channels of the television of the home entertaining appliance 30 by pressing the UP or DOWN keys thereof. The user may then operate the control keys 11 by a single hand, in which the user's palm will hold the body of the housing 50, the fingers will operate on the control keys 11.

The control keys 11 may also have a mute key, volume control, setting control, etc., so that the user is able to selectively browse the selections of the appliance 30 for controlling thereof in any conventional browsing control manner. The control keys 11 may further comprises a power key for controllably turning on or off of the appliance 30 in the remote control manner. According to the preferred embodiment of the present invention, the control keys 11 are embodied as four direction keys and an input key for allowing the user of the remote controller to direct the cursor on the screen of the home entertaining appliance 30 so as to control an operation thereof. The control keys 11 are spacedly provided on the upper portion of the housing 50 for convenient use by the user.

The full keyboard arrangement 12 is provided on the housing 50 and has a full keyboard set 121 comprising a plurality of information keys 122 for being selectively pressed to input at least one command to the corresponding the CPU 40.

On the other hand, the output module 20 is electrically connected to the CPU 40 and wirelessly linked with the home entertaining appliance 30 for wirelessly transmitting the inputted commands of the input module 10 to the home entertaining appliance 30, such that the user is able to remotely control the appliance 30 via the input module 10 of the remote controller.

According to the preferred embodiment of the present invention, the full keyboard set 121 has a plurality of information keys 122 integrally located on a surface of the remote controller (i.e. the housing 50). Each of the information keys 122 has corresponding characters thereon, and preferably being arranged to form the standard layouts of the information keys 122, so that the user is able to familiarly press the information keys 122 simultaneously or in sequence in order to input the corresponding commands. Therefore, the remotely controller is able to easily and remotely controlled via the full keyboard arrangement 12 for communicating with the appliances 30 via the remote controller. In this preferred embodiment, the information keys 122 are spacedly provided on a lower portion of the housing 50 so as to allow a user to control the information keys 122 by using both of his or her hands.

Accordingly, the remote controller is being programmed, so that the user is able to input the information via the full keyboard set 121 for directly searching the selections of the appliance 30. For example, when the appliance 30 is a television and a user needs to search channels, the user is able to input the information keys 122 in series to spell the name of the channel, so that after the user has input the signal of the channel information of the television, the remote controller is able to transmit the command action via the output module 20 to switch to the desired channel. Therefore, the remote controller eliminates the browsing process for selecting the selections from the enormous database of the appliance 30.

In the preferred embodiment of the present invention, the information keys 122 preferably have characters set physically or virtually appeared thereon, such as the English letters A to Z of the characters printed thereon for pressing or physically typing the combinations of a channel's name of television, wherein the numbers from one to zero also appear on the information keys 122 for sharing part of the information keys 122 with the characters, so as to save the required space of the information keys 122. In other words, there is no need for another set of keys separately provided for the numbers. The shared numbers and characters of the information keys 122 are able to form a relatively more compact size of the remote controller. The size of the remote controller is preferably within the range of 11 cm in length, 7 cm in width, and 2 cm in thickness, so that the remote controller is able to form the predetermined compact size while being able to provide comfortable pressing size for the finger tips of the user to enter the information keys 122 of the full keyboard arrangement 12.

The output module 20 preferably comprises a transmitting unit 21 for electrically and wirelessly communicating with a receiver 31 of each of the home entertaining appliances 30. The transmitting unit 21 may wirelessly transmit the inputted signals to the receiver 31 via infrared radiation, radio frequency, WiFi, blue ray, etc., so that the remote controller is able to remotely and wirelessly communicate with one or more home entertaining appliance 30 via the input module 10.

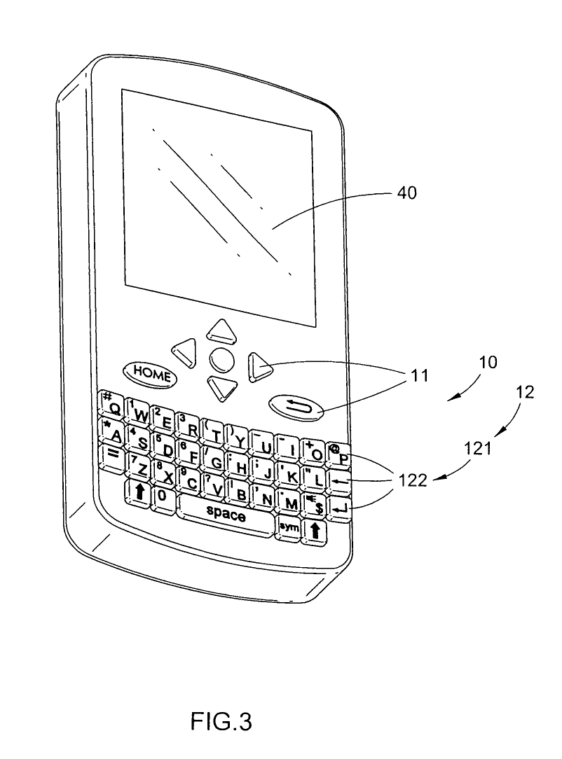

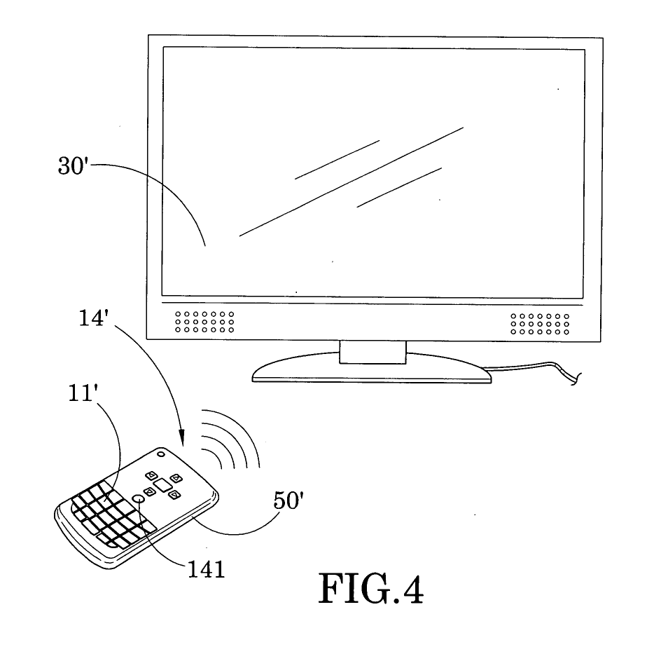

As shown in FIG. 3 of the drawings, an alternative remote controller according to the above preferred embodiment of the present invention is further illustrated, wherein the remote controller has similar structure and function as mentioned above, wherein the remote controller further comprises a display module 40 electrically linking to the CPU unit thereof for displaying the corresponding information of the appliances 30.

The display module 40 of the remote controller may be programmed that the display module 40 is able to instantly and simultaneously showing the information related to the current audio or video information that the home entertaining appliance 30 is playing. For instance, the display module 40 is able to show the television channel information which is currently playing on the television screen of the home entertaining appliance 30.

It should be noted that the information keys 122 of the full keyboard arrangement 12 can be a virtual full keyboard set 121, such as virtually shown on a touch screen display of the display module 40 of the remote controller, so that the user is able to press the corresponding location of the information keys 122 on the touch screen. Moreover, the control keys 121 can also be formed on the touch screen display module 40 so that the user may simply control the home entertaining appliance 30 through the touch screen technology.

Referring to 4 of the drawings, a first alternative mode of the remote controller according to the preferred embodiment of the present invention is illustrated. The first alternative mode is similar to the preferred embodiment, except the input module 10′ further comprises a cursor controller 14′ provided on the housing 50′ (preferably between the control keys 11′ and the information keys 122′) and is electrically connected to the CPU 40 for allowing the user to control a movement of the cursor on the screen of the home entertaining appliance 30′ (such as a television). More specifically, the cursor controller 14′ comprises a track ball 141′ rotatably provided on a mid-portion of the housing 50′, wherein a diameter of the track ball 141′ is corresponding with a size of a user's finger so as to allow the user to touch and rotate the track ball 141′ by his or her finger for controlling the movement of the cursor on the screen of the home entertaining appliance 30′. In other words, the cursor controller 14′ provides an alternative way or supplement of controlling cursor movement apart from the control keys 11′.

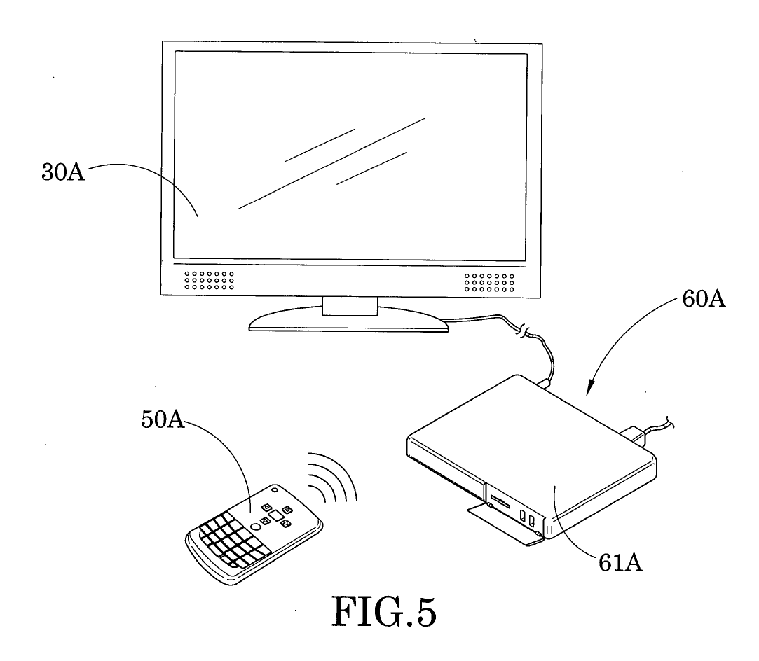

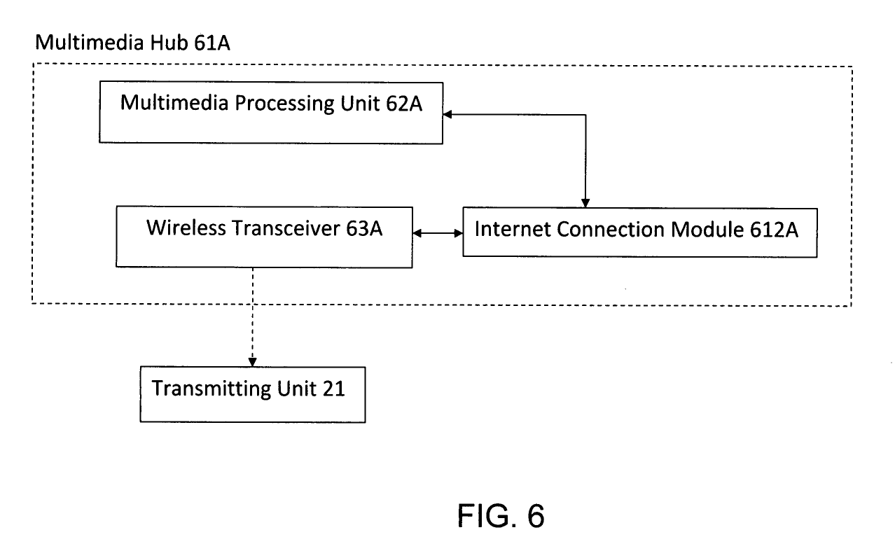

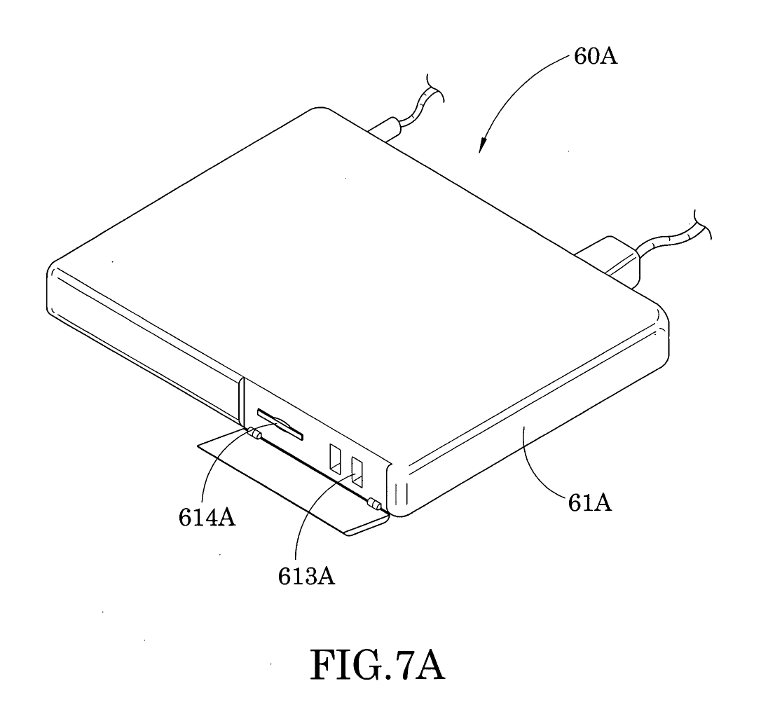

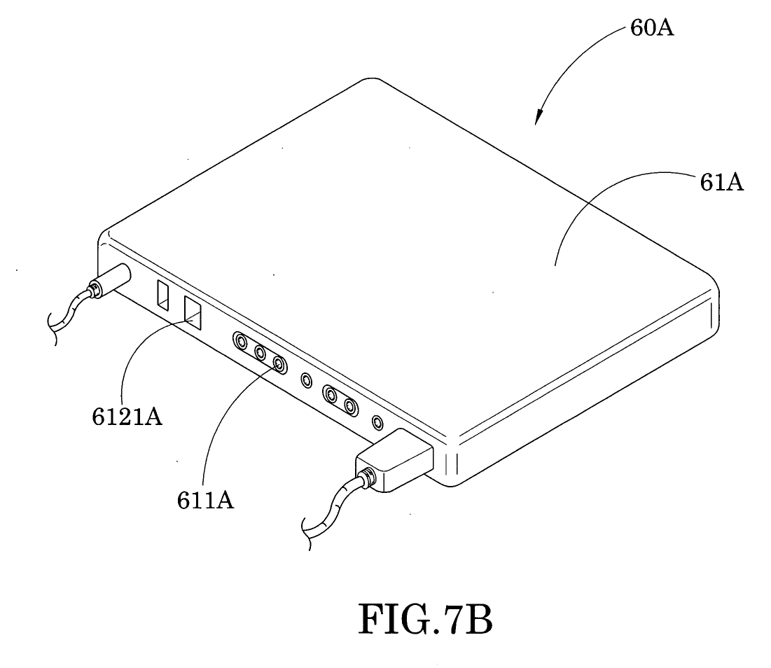

Referring to FIG. 5, FIG. 6, FIG. 7A to FIG. 7B of the drawings, a second alternative mode of the remote controller according to the preferred embodiment of the present invention is illustrated. The second alternative mode is similar to the preferred embodiment, except that the remote controller further comprises a multimedia controller 60A electrically connected between the housing 50A and the home entertaining appliance 30A for supporting a wide range of multimedia functions.

According to the second alternative mode, the multimedia controller 60A comprises a controller hub 61A and a multimedia processing unit 62A for processing multimedia material and displaying it on the home entertaining appliance 30A. The multimedia controller 60A further comprises a wireless transceiver 63A supported by the controller hub 61A and is electrically connected to the multimedia processing unit 62A, wherein the wireless transceiver 63A is arranged to receive wireless signal from the transmitting unit 21. The wireless signal is then processed and executed by the multimedia processing unit 62A.

The multimedia controller 60A further comprises a plurality of AV output ports 611A spacedly provided on the multimedia hub 61A for electrically connecting with the home entertaining appliance 30A preferably through data cables such as a HDMI cable, wherein multimedia materials processed by the multimedia processing unit 62A are transferred to the home entertaining appliance 30A through the AV output ports 611A.

Moreover, the multimedia controller 60A further comprises an internet connection module 612A received in the multimedia hub 61A for accessing internet. The internet connection module 612A comprises an internet port 6121A formed on the multimedia hub 61A for electrically connecting with a data line (such as a DSL line) or cable for acquiring internet access. Moreover, the internet connection module 612A is electrically connected to the wireless transceiver 63A for acquiring internet access from an external source in a wireless manner. Multimedia materials acquired from internet can be transferred and played on the home entertaining appliance 30A, such as a LCD television.

The multimedia controller 60A further comprises a plurality of USB ports 613A and a card reader 614A provided on the multimedia hub 61A for connecting with a USB port of another device and for reading storage cards respectively. In other words, the multimedia material can be acquired from a computer or a storage card and is processed by the multimedia processing unit 62A and displayed on the home entertaining appliance 30A. The multimedia controller 60A can be controlled by the remote controller mentioned above.

From the above description, it can be shown that the remote controller of the present invention can be used to control the home entertaining appliance 30, and can also be used to control playing of multimedia material through the multimedia controller 60A.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A remote controller for at least one home entertaining appliance, comprising:
a housing;
a central processing unit received in said housing;
an input module electrically connected to said CPU for selectively inputting signals into said remote controller to controllably communicate with said home entertaining appliance, wherein said input module comprises:
a plurality of control keys provided on said housing for allowing a user to input at least one command to said CPU for interactively communicating with said home entertaining appliance; and
a full keyboard arrangement provided on said housing and has a full keyboard set comprising a plurality of information keys for being selectively pressed to input at least one command to said corresponding said CPU; and
an output module electrically connected to said CPU and wirelessly linking with said home entertaining appliance for wirelessly transmitting said inputted commands of said input module to said home entertaining appliance, such that said user is able to remotely control said appliances via said input module of said remote controller.

2. The remote controller, as recited in claim 1, wherein said control keys are provided on an upper portion of said housing for allowing a user to input at least one command to said CPU for interactively communicating with said home entertaining appliance.

3. The remote controller, as recited in claim 2, wherein said information keys are spacedly provided on a lower portion of said housing wherein each of said information keys has a corresponding character formed thereon so that a user is allowed to input character information to said CPU for controlling said home entertaining appliance.

4. The remote controller, as recited in claim 2, wherein said output module comprises a transmitting unit for electrically and wirelessly communicated with a receiver of said home entertaining appliance.

5. The remote controller, as recited in claim 3, wherein said output module comprises a transmitting unit for electrically and wirelessly communicated with a receiver of said home entertaining appliance.

6. The remote controller, as recited in claim 4, wherein said further comprising a display module electrically connected to said CPU thereof for interactively displaying corresponding information of said appliance.

7. The remote controller, as recited in claim 5, wherein said further comprising a display module electrically connected to said CPU thereof for interactively displaying corresponding information of said appliance.

8. The remote controller, as recited in claim 3, wherein said input module further comprises a cursor controller provided on said housing and is electrically connected to said CPU for allowing said user to control a movement of said cursor on said screen of said home entertaining appliance.

9. The remote controller, as recited in claim 5, wherein said input module further comprises a cursor controller provided on said housing and is electrically connected to said CPU for allowing said user to control a movement of said cursor on said screen of said home entertaining appliance.

10. The remote controller, as recited in claim 7, wherein said input module further comprises a cursor controller provided on said housing and is electrically connected to said CPU for allowing said user to control a movement of said cursor on said screen of said home entertaining appliance.

11. The remote controller, as recited in claim 8, wherein said cursor controller comprises a track ball rotatably provided on a mid-portion of said housing, wherein a diameter of said track ball is corresponding with a size of a user's finger so as to allow said user to conveniently touch and rotate said track ball for controlling said home entertaining appliance.

12. The remote controller, as recited in claim 9, wherein said cursor controller comprises a track ball rotatably provided on a mid-portion of said housing, wherein a diameter of said track ball is corresponding with a size of a user's finger so as to allow said user to conveniently touch and rotate said track ball for controlling said home entertaining appliance.

13. The remote controller, as recited in claim 10, wherein said cursor controller comprises a track ball rotatably provided on a mid-portion of said housing, wherein a diameter of said track ball is corresponding with a size of a user's finger so as to allow said user to conveniently touch and rotate said track ball for controlling said home entertaining appliance.

14. The remote controller, as recited in claim 2, further comprising a multimedia controller electrically connected between said housing and said home entertaining appliance for supporting a wide range of multimedia functions.

15. The remote controller, as recited in claim 10, further comprising a multimedia controller electrically connected between said housing and said home entertaining appliance for supporting a wide range of multimedia functions.

16. The remote controller, as recited in claim 13, further comprising a multimedia controller electrically connected between said housing and said home entertaining appliance for supporting a wide range of multimedia functions.

17. The remote controller, as recited in claim 14, wherein said multimedia controller comprises a controller hub, a multimedia processing unit for processing multimedia material and displaying it on said home entertaining appliance, and a wireless transceiver supported by said controller hub and is electrically connected to said multimedia processing unit, wherein said wireless transceiver is arranged to receive wireless signal from said transmitting unit.

18. The remote controller, as recited in claim 15, wherein said multimedia controller comprises a controller hub, a multimedia processing unit for processing multimedia material and displaying it on said home entertaining appliance, and a wireless transceiver supported by said controller hub and is electrically connected to said multimedia processing unit, wherein said wireless transceiver is arranged to receive wireless signal from said transmitting unit.

19. The remote controller, as recited in claim 16, wherein said multimedia controller comprises a controller hub, a multimedia processing unit for processing multimedia material and displaying it on said home entertaining appliance, and a wireless transceiver supported by said controller hub and is electrically connected to said multimedia processing unit, wherein said wireless transceiver is arranged to receive wireless signal from said transmitting unit.

20. The remote controller, as recited in claim 17, wherein said multimedia controller further comprises a plurality of AV output ports spacedly provided on said multimedia hub for electrically connecting with said home entertaining appliance, wherein multimedia material is processed by said multimedia processing unit and is transferred to said home entertaining appliance through said AV output ports.

21. The remote controller, as recited in claim 18, wherein said multimedia controller further comprises a plurality of AV output ports spacedly provided on said multimedia hub for electrically connecting with said home entertaining appliance, wherein multimedia material is processed by said multimedia processing unit and is transferred to said home entertaining appliance through said AV output ports.

22. The remote controller, as recited in claim 19, wherein said multimedia controller further comprises a plurality of AV output ports spacedly provided on said multimedia hub for electrically connecting with said home entertaining appliance, wherein multimedia material is processed by said multimedia processing unit and is transferred to said home entertaining appliance through said AV output ports.

23. The remote controller, as recited in claim 20, wherein said multimedia controller further comprises an internet connection module received in said multimedia hub for accessing internet, wherein said internet connection module comprises an internet port formed on said multimedia hub for electrically connecting with a data line for acquiring internet access.

24. The remote controller, as recited in claim 21, wherein said multimedia controller further comprises an internet connection module received in said multimedia hub for accessing internet, wherein said internet connection module comprises an internet port formed on said multimedia hub for electrically connecting with a data line for acquiring internet access.

25. The remote controller, as recited in claim 22, wherein said multimedia controller further comprises an internet connection module received in said multimedia hub for accessing internet, wherein said internet connection module comprises an internet port formed on said multimedia hub for electrically connecting with a data line for acquiring internet access.

26. The remote controller, as recited in claim 23, wherein said multimedia controller further comprises a plurality of USB ports and a card reader provided on said multimedia hub for connecting with a USB port of another device and for reading storage cards respectively.

27. The remote controller, as recited in claim 24, wherein said multimedia controller further comprises a plurality of USB ports and a card reader provided on said multimedia hub for connecting with a USB port of another device and for reading storage cards respectively.

28. The remote controller, as recited in claim 25, wherein said multimedia controller further comprises a plurality of USB ports and a card reader provided on said multimedia hub for connecting with a USB port of another device and for reading storage cards respectively.
